(19) United States
(12) Patent Application Publication
(10) Pub. No.: US 2015/0124650 A1
(43) Pub. Date: May 7, 2015

(54) SYSTEMS AND METHODS FOR COGNITIVE RADIO COMMUNICATIONS

(71) Applicants: Saswat MISRA, New York, NY (US); Jari HÄMÄLÄINEN, Kangasala As (FI); Andrew K. LANG, New York, NY (US); Ismail MOHAMUD, Flower Mound, TX (US); Kunal SHARMA, New Delhi (IN)

(72) Inventors: Saswat MISRA, New York, NY (US); Jari HÄMÄLÄINEN, Kangasala As (FI); Andrew K. LANG, New York, NY (US); Ismail MOHAMUD, Flower Mound, TX (US); Kunal SHARMA, New Delhi (IN)

(73) Assignee: VRINGO LABS LLC

(21) Appl. No.: 14/535,287

(22) Filed: Nov. 6, 2014

Related U.S. Application Data
(60) Provisional application No. 61/900,747, filed on Nov. 6, 2013.
(60) Provisional application No. 61/900,773, filed on Nov. 6, 2013.
(60) Provisional application No. 61/900,783, filed on Nov. 6, 2013.
(60) Provisional application No. 61/900,803, filed on Nov. 6, 2013.
(60) Provisional application No. 61/900,813, filed on Nov. 6, 2013.
(60) Provisional application No. 61/900,823, filed on Nov. 6, 2013.
(60) Provisional application No. 61/900,830, filed on Nov. 6, 2013.
(60) Provisional application No. 61/900,853, filed on Nov. 6, 2013.

(51) Int. Cl. H04W 48/14; H04W 28/02; H04W 72/04

(52) U.S. Cl. CPC H04W 48/14; H04W 72/0413; H04W 28/0215; H04W 72/048; H04W 84/18
USPC 370/254; 370/329; 370/259

(57) ABSTRACT

Disclosed herein are techniques for granting access to a mobile device on a network. An access request is received from the mobile device. A communication score, a content score, and a reputation score associated with the mobile device is determined. An access policy for the mobile device on the network is set based on at least one of the communications score, the content score, and the reputation score.

### RELATED APPLICATIONS

This application claims priority from U.S. Provisional Patent Application Ser. No. 61/900,747 filed on Nov. 6, 2013; Ser. No. 61/900,773 filed on Nov. 6, 2013; Ser. No. 61/900,783 filed on Nov. 6, 2013; Ser. No. 61/900,803 filed on Nov. 6, 2013; Ser. No. 61/900,813 filed on Nov. 6, 2013; Ser. No. 61/900,823 filed on Nov. 6, 2013; Ser. No. 61/900,830 filed on Nov. 6, 2013; Ser. No. 61/900,853 filed on Nov. 6, 2013.

### FIELD

The present disclosure relates to techniques of data exchange in a sink-based network topology and, more particularly, to techniques for routing data to and data from mobile devices and data sinks, techniques for establishing mobile swarm-based communications in, inter alia, the context of vehicular networks, and various techniques for managing a cognitive radio network.

### BACKGROUND

Modern mobile devices, including smartphones, tablets, portable digital assistants (PDAs) and other devices, generally rely on network-connectivity (e.g., a cellular, WiFi, RFID, or Bluetooth connection to the Internet) to provide content and, hence, value to a user. These devices are often being used in rapidly mobile settings, such as on trains, in cars, and on airplanes. Currently, a group of mobile devices located in an area will each establish their own personal network connections (e.g., to the Internet). Further, these devices typically do not directly exchange information with each other.

Existing mobile wireless communications occur primarily through single-hop cellular phone to base station communications. This form of communications has several disadvantages. First, because base stations are typically located distant from cell phones, this form of communications results in a large number of high power signals that generally pollute the radio frequency (RF) spectrum. Power usage will further increase as cellular communications move to higher frequency bands (as may happen in the near future based on multiple government and FCC initiatives). Second, coverage is inherently limited to a typically small number of base stations that are available to a mobile phone at any given time. If none of these small number of base stations are able to provide adequate service, the communications quality suffers. Third, the expense of owning and operating cellular base stations and other communications equipment is often prohibitive, and this limits the amount of competition for mobile device users. This in turns leads to potentially higher costs and lower service quality than would otherwise be the case. Accordingly, it would be desirable to implement a different kind of network communications architecture that incentives high quality communications, competition, and spectral efficiency among mobile users.

Applications and services that incorporate a position of a mobile phone are becoming ever more ubiquitous. Social media mobile applications such as Facebook and Foursquare, business and site review applications such as Yelp, and various mapping services mobile applications such as Apple Maps are just a small number of popular mobile applications that purport to enrich and simplify user's lives through the use of location services. Mobile phones also use location information to perform core network functions. For example, emergency response, call handover, and stolen phone location are all services that a telecommunications provider may provide to its users based on location information. Location information is typically derived at a phone via GPS.

However, despite the rising popularity and necessity for a phone to have accurate location information at all times, GPS-based location is not always available to a phone. For example, GPS location may not be available when a phone is located indoors, underground, in an area with significant obstructions, in an area with limited cellular coverage, and/or in a part of the world with insufficient communications to an adequate number of GPS satellites.

Radio networks are becoming increasingly heterogeneous in the communications needs of devices in the network. For example, a typical cellular network simultaneously supports devices manufactured by five or more manufacturers and, at any given time, the various devices may have very different communications requirements. For example, one device may require a large throughput and low latency for a video call while another device may require only a minimal throughput and be latency-tolerant for use in a limited Internet session.

While wireless phone were once the province of the wealthy, they have now become commodity devices that are in widespread use by all income-brackets in society. Accordingly, two users within a given radio network may have very different degrees of price sensitivity in what they are willing to pay for communications resources. At the same time, the communications resources available in wireless networks are increasingly becoming scarce. For example, wireless spectrum is rapidly being consumed by the needs of modern wireless smartphones, tablets, laptops, and the like. Accordingly, it is particularly important the limited resources in a radio network by allocated to those nodes that truly need and are willing to pay for them.

One strength of current and envisioned cognitive radios is their ability to operate in a wide range of network conditions and over a wide range of network communications constraints. In particular, a cognitive radio can adapt its communication parameters (e.g., power, modulation, spectrum access algorithm, and/or cooperation strategy) “on the fly” to increase a number of users and amount of data that can be packed into a fixed amount of spectrum, thereby addressing concerns about spectrum scarcity as a larger number of devices and bandwidth hungry applications crowd the existing spectrum. While the flexibility and non-standardized nature of cognitive radio communications is generally positive, there are certain drawbacks.

One drawback of the freedom afforded to cognitive radio communications is that a malicious or selfish cognitive radio is capable of “commandeering” the wireless spectrum. For example, by transmitting at very high power and/or transmitting information without regard to the communications of other radios, a malicious or selfish cognitive radio can greatly diminish and even destroy the overall utility of a network (ironically, even its own utility, if other radios boost their own communications “aggressiveness” in an attempt to communicate).

Identifying and penalizing selfish or malicious behavior is possible but often a human user of the misbehaving cognitive radio is anonymous or otherwise hard to ascertain.

Modern mobile devices, including smartphones, tablets, portable digital assistants (PDAs) and other devices, generally rely on network-connectivity (e.g., a cellular, WiFi, RFID, or Bluetooth connection to the Internet) to provide content and, hence, value to a user. Currently, a group of mobile devices located in an area will each establish their own personal network connections to an access point with only limited evaluation of the relative merits of all available access points. Further, these devices typically do not directly exchange information with each other.

Bandwidth sharing, in particular, is a key feature of many cognitive radios. Bandwidth sharing effectively allows a cognitive radio to “share” its bandwidth with a neighboring cognitive radio. For example, a first cognitive radio may allow a second cognitive radio to use the first cognitive radio as a relay to an access point. Alternatively, the first cognitive radio may allow a second cognitive radio use time slots or orthogonal channels initially reserved for the first cognitive. Each of these techniques increasing an effective bandwidth of the second cognitive radio. Existing techniques to bandwidth sharing typically require that a user decide to allow bandwidth sharing.

### SUMMARY

Accordingly, presented herein are techniques for granting access to a mobile device on a network. An access request is received from the mobile device. A communication score, a content score, and a reputation score associated with the mobile device is determined. An access policy for the mobile device on the network is set based on at least one of the communications score, the content score, and the reputation score.

Accordingly, presented herein are techniques for establishing mobile swarm-based communications in, inter alia, the context of vehicular networks. More detail, disclosed herein are techniques for forming a mobile swarm. A set of mobile devices in vicinity of a lead device is identified at the lead device. A mobility vector of the lead device is compared to mobility vectors of each of the other mobile devices in the set of mobile devices. A determination of whether to include a given mobile device of the set of mobile devices in the swarm is based on the comparing.

Accordingly, presented herein are localization-based techniques for determining a position of a radio node through received signal power measurements. In more detail, disclosed herein are techniques for determining a location of a mobile phone from local measurements. Local nodes in vicinity of the mobile phone and their known positions are identified at the mobile phone. A set of nodes from the identified local nodes is selected. Received power measurements are taken with respect to each node in the selected set of nodes at one or more locations. A global position of the mobile phone is determined based on the received power measurements.

Accordingly, presented herein are techniques for allocating resources among radios in a wireless radio network. In more detail, disclosed herein are techniques for allocating resources among radios in a wireless radio network. A VIP radio in a radio network is identified. At least one communications need of the VIP radio is elicited. A transmission of the at least one communications need is caused to one or more secondary radios. A referral fee is received from the VIP radio.

Accordingly, presented herein techniques for identifying and penalizing selfish or malicious behavior of a radio in a cognitive radio network. Selfish communications behavior of a first cognitive radio is identified. The identified selfish behavior of the first cognitive radio is validated by communicating with a second cognitive radio. A central authority is provided with information indicative of the selfish behavior of the first cognitive radio in response to the validation.

Accordingly, presented herein techniques for penalizing a user of a cognitive radio. A request is received to use a wireless cognitive radio device, where the request is encrypted and includes a real-world human identity of a requestor. The real-world human identity is decrypted and the requestor is granted a right to use the wireless cognitive radio device. Communications behavior of the wireless cognitive radio device is monitored to detect potential selfish or malicious behavior by the requestor. A record is made of the real-world human identity of the requestor if selfish or malicious behavior is detected.

Accordingly, presented herein are techniques for determining a network hierarchy in a cognitive radio network. A set of mobile devices in vicinity of each other is identified, where the set of mobile devices form a communications cluster. A cluster leader is nominated based on service-based scores each of the mobile devices in the communications cluster. A base station for the cluster leader to communicate with is identified based on service-based scores for a plurality of base stations in communications range of the cluster leader.

Accordingly, presented herein are techniques for the automatic sharing of bandwidth between cognitive radios. Disclosed herein are techniques for determining whether to share bandwidth with a second cognitive radio. A request to share bandwidth with the second cognitive radio is received at a first cognitive radio. One or more intrinsic factors associated with the first cognitive radio are determined. One or more extrinsic factors related to bandwidth sharing are determined. It is determined whether to allow bandwidth sharing with the second cognitive radio based on the one or more intrinsic factors and the one or more extrinsic factors.

Accordingly, presented herein are techniques for determining a location of a mobile phone from local measurements, the method comprising: identifying, at the mobile phone, local nodes in vicinity of the mobile phone and known positions of each of the local nodes; selecting a set of nodes from the identified local nodes; taking received power measurements with respect to each node in the selected set of nodes at one or more locations; and determining a global position of the mobile phone based on the received power measurements.

The method further comprises determining that a global source of position information is unavailable at the mobile phone.

According to the method, the selected set of nodes comprises at least one emergency beacon station.

According to the method, the taking receiving power measurements with respect to a given node in the selected set of nodes at a given location comprises: transmitting a request for a beacon signal; and in response to the request, receiving, at the given location, the beacon signal from the given node.

According to the method, the identifying local nodes in vicinity of the mobile phone and known positions of each of the local nodes comprises providing payment to a local node in exchange for position information of the local node.

Accordingly, presented herein are techniques for allocating resources among radios in a wireless radio network, the method comprising: identifying a VIP radio in a radio network; eliciting at least one communications need of the VIP radio; causing a transmission of the at least one communications need to one or more secondary radios; and receiving a referral fee from the VIP radio.

According to the method, identifying the VIP radio comprises causing a transmission of a query message to the VIP radio and, in response to the transmission, receiving a response message which identifies the VIP node.

According to the method, identifying the VIP radio comprises inferring VIP radio status from one or more request messages transmitted by the VIP radio.

Accordingly, presented herein are techniques for penalizing a cognitive radio, the method comprising: identifying selfish communications behavior of a first cognitive radio; communicating with a second cognitive radio to validate the identified selfish behavior of the first cognitive radio; and in response to validation, providing a central authority with information indicative of the selfish behavior of the first cognitive radio.

The method for penalizing includes verifying that communications of the first cognitive radio adheres to terms of the punishment warrant over a period of time.

According to the method, the identified selfish communications behavior comprises at least one of (a) transmitting with an unusually large amount of transmission power, (b) not adhering to silent periods in communications, (c) beginning a transmission even when another node in vicinity of the first cognitive radio is already transmitting, and (d) engaging in jamming the communications of other nodes.

Accordingly, presented herein are techniques for penalizing a user of a cognitive radio, the method comprising: receiving a request to use a wireless cognitive radio device, the request encrypted and including a real-world human identity of a requestor; decrypting the real-world human identity and granting the requestor a right to use the wireless cognitive radio device; monitoring communications behavior of the wireless cognitive radio device to detect potential selfish or malicious behavior by the requestor; and making a record of the real-world human identity of the requestor if selfish or malicious behavior is detected.

The method for penalizing includes delivering, to the wireless cognitive radio device, a digitally signed punishment warrant if selfish or malicious behavior is detected.

Accordingly, presented herein are techniques for determining a network hierarchy comprising: identifying a set of mobile devices in vicinity of each other, the set of mobile devices forming a communications cluster; nominating a cluster leader based on service-based scores each of the mobile devices in the communications cluster; and identifying a base station for the cluster leader to communicate with based on service-based scores for a plurality of base stations in communications range of the cluster leader.

According to the method, the service-based scores of each mobile devices comprises at least one Klout score.

According to the method, identifying the set of mobile devices comprises retrieving score data from a third-party data service at a first time interval, and identifying the base station for the cluster leader to communicate with comprises retrieving score data from the third-party data service at a second time interval occurring after conclusion of the first time interval.

Accordingly, presented herein are techniques for determining whether to share bandwidth with a second cognitive radio, the method comprising: receiving, at a first cognitive radio, a request to share bandwidth with the second cognitive radio; determining one or more intrinsic factors associated with the first cognitive radio; determining one or more extrinsic factors related to bandwidth sharing; determining whether to allow bandwidth sharing with the second cognitive radio based on the one or more intrinsic factors and the one or more extrinsic factors.

According to the method, the one or more intrinsic factors include one or more of a battery level of the first cognitive radio, a portion of bandwidth of the first cognitive radio currently in use, and application-specific quality of service requirements of an application in use by the first cognitive radio.

According to the method, the one or more extrinsic factors include one or more of a reputation of the second cognitive radio, a monetary value of bandwidth sharing to the first cognitive radio, and a prediction of connection disruption between the first cognitive radio and the second cognitive radio.

According to the method, determining whether to allow bandwidth sharing with the second cognitive radio comprises accessing a threshold value associated with the one or more intrinsic factors and the one or more extrinsic factors.

According to the method for determining whether to share bandwidth further comprises receiving, the first cognitive radio, payment from the second cognitive radio if bandwidth sharing between the first cognitive radio and the second cognitive radio is allowed.

According to the method, the one or more extrinsic factors include one or more of a reputation of the second cognitive radio, a monetary value of bandwidth sharing to the first cognitive radio, and a prediction of connection disruption between the first cognitive radio and the second cognitive radio.

According to the method for determining whether to share bandwidth further comprises receiving, the first cognitive radio, payment from the second cognitive radio if bandwidth sharing between the first cognitive radio and the second cognitive radio is allowed, wherein determining whether to allow bandwidth sharing with the second cognitive radio comprises accessing a threshold value associated with the one or more intrinsic factors and the one or more extrinsic factors.

The method for determining a network hierarchy comprises: identifying a set of mobile devices in vicinity of each other, the set of mobile devices forming a communications cluster; nominating a cluster leader based on service-based scores each of the mobile devices in the communications cluster; and identifying a base station for the cluster leader to communicate with based on service-based scores for a plurality of base stations in communications range of the cluster leader.

The method identifies the set of mobile devices in vicinity of each other comprises at least one of determining whether a set of GPS coordinates associated with a first mobile device in the set of mobile devices falls within a prescribed geographic region and retrieving score data from a third-party data service at a first time interval, and identifying the base station for the cluster leader to communicate with comprises retrieving score data from the third-party data service at a second time interval occurring after conclusion of the first time interval

The method provides that the service-based score for a base station in the plurality of base stations is based on a frequency of any outages historically experienced by that base station.

### BRIEF DESCRIPTION OF DRAWINGS

Aspects and features of the presently-disclosed systems and methods will become apparent to those of ordinary skill in the art when descriptions thereof are read with reference to the accompanying drawings, of which:

FIG. 1 depicts a topology for a radio network; and

FIG. 2 depicts an illustrative process in which a WiFi sink operator sets an access policy for a mobile device to participate in a WiFi sink network in accordance with an embodiment.

FIG. 3 depicts an illustrative process for establishing swarm-based mobile communications in accordance with an embodiment.

FIG. 4 depicts an illustrative localization-based process for determining a position of a radio node through received signal power measurements in accordance with an embodiment.

FIG. 5 depicts an illustrative process for allocating resources among radios in a wireless radio network according to communications needs and price sensitivity in accordance with an embodiment.

FIG. 6 depicts an illustrative process for identifying and penalizing selfish or malicious behavior of a radio in a cognitive radio network in accordance with an embodiment.

FIG. 7 depicts an illustrative process for identifying and penalizing selfish or malicious behavior of a radio in a cognitive radio network in accordance with an embodiment.

FIG. 8 depicts an illustrative process for establishing a communications hierarchy in a cognitive radio network.

FIG. 9 depicts an illustrative process for enabling an automatic sharing of bandwidth between cognitive radios in accordance with an embodiment.

### DETAILED DESCRIPTION

Hereinafter, embodiments of the presently-disclosed systems and methods are described with reference to the accompanying drawings. Like reference numerals may refer to similar or identical elements throughput the description of the figures.

As would be understood by one of ordinary skill, based on the disclosure and teachings herein, the terms “phone” and “terminal” are used interchangeably throughout this disclosure.

As will be understood by one of ordinary skill in the art, based on the disclosure and teachings herein, the terms “node” “radio” “device” and “mobile device” are used interchangeably throughout this disclosure. A mobile device may be, e.g., a mobile phone (e.g., a smartphone), tablet, navigation system, laptop, portable digital assistant (PDA), or smart watch device.

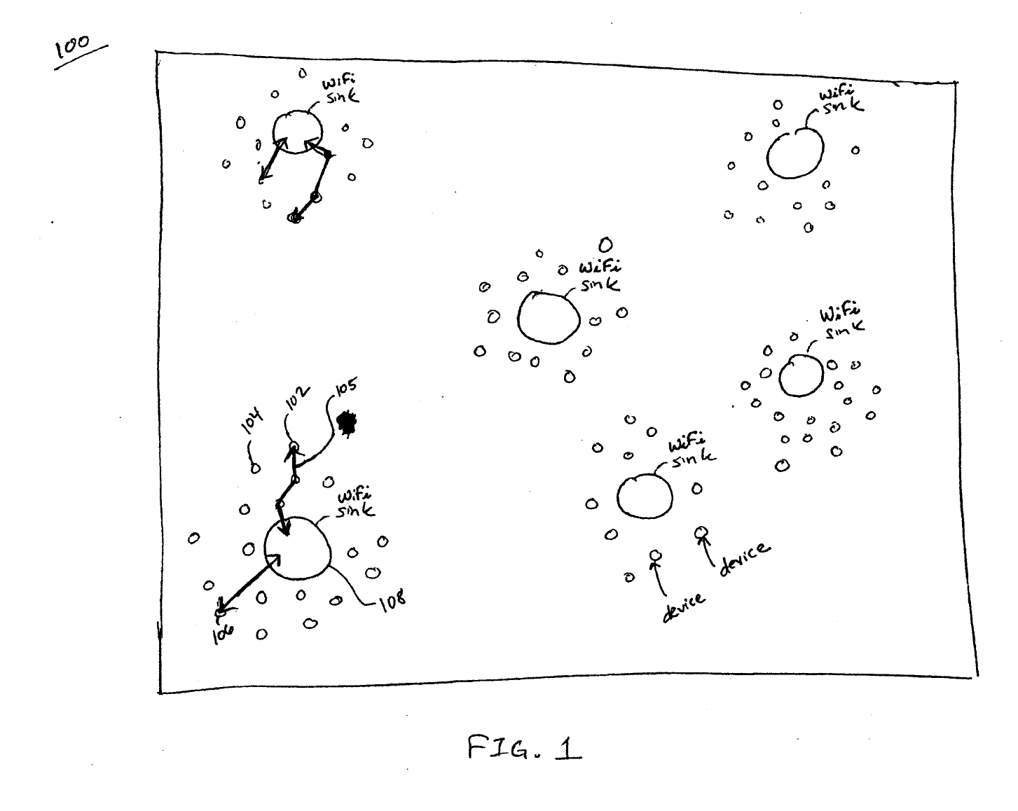

FIG. 1 depicts a topology for a radio network. The topology includes a number of data sinks (also referred to as “hotspots”), e.g., data sink 108. As an illustrative example, each data sink is labeled a WiFi sink, indicating that it receives and transmits data according to a WiFi protocol. However, as would be understood by one of ordinary skill, based on the disclosure and teachings herein, each of the sinks may receive and transmit data according to any other suitable wireless protocol.

At any given time, each data sink is responsible for receiving data from, and forwarding data to, a number of mobile devices. For example, the data sink 108 is associated with mobile devices 102 and 104, in addition to other mobile devices. The various mobile devices associated with a data sink need not be produced by the same manufacturer or operate according to the same protocol. As an illustrative example, the mobile device 102 may be a phone manufactured by Apple and operating according to an LTE protocol, while the mobile device 104 may be a phone manufactured by LG Electronics and operating to a CDMA protocol. Further, the mobile devices depicted in FIG. 1 may correspond variously to cell phones, tablets, laptops, desktop computers, and portable digital assistants.

At any given time, each mobile device depicted in FIG. 1 sends its data to exactly one of the WiFi sinks shown in FIG. 1 (although the WiFi sink so nominated may change over time). In particular, devices may send data directly to a WiFi sink in one “hop” or indirectly through multiple hops and by using intermediate devices as relays. For example, in FIG. 1, the mobile device 106 sends data directly to the WiFi sink 108, while the mobile device 102 sends data indirectly to the WiFi sink 108 via two intermediary mobile devices. The communications between any two mobile devices occurs according to any suitable mobile-to-mobile communications protocol. For example, the communications may occur according to a WiFi protocol or an LTE Direct protocol depending on the respective capabilities of the two mobile devices involved in a call.

Each mobile device may maintain a listing of “backup” WiFi sinks to use in case communications becomes unresponsive with respect to its currently-nominated WiFi sink. As illustrated in FIG. 1, WiFi sinks are irregularly placed in a region. In one arrangement, all WiFi sinks in a given region are controlled by a single entity (e.g., Time Warner Cable), while, in another arrangement, a wide variety of different persons/entities own and operate the various WiFi sinks in an area (e.g., a bodega owner, a food truck owner, and a Laundromat owner in New York City may separately purchase and install their own WiFi sinks for public use). Generally, the owner of a WiFi sink charges devices for the use of the WiFi sink.

WiFi sinks are generally irregularly spaced in a geographic area based on the opportunities perceived by WiFi sink providers. Further, a given network, such as the one pictured in FIG. 1, may be on the order of hundreds of square miles, much larger, or much smaller. FIG. 1 shows devices “clumped” around WiFi sinks and this may be the case, e.g., in rural communities that have WiFi sinks centered in population hubs (e.g., popular shopping areas). However, in many scenarios, e.g., in a densely packet urban area, devices will be more uniformly distributed through a given geographic area and potentially a large number of mobile-to-mobile hops will be used to connect a given device to a WiFi sink.

One question is how a particular device chooses which WiFi sink to join. In one arrangement, the device follows shortest path routing according to a “communications score” link metric associated with each D2D and device-to-WiFi sink route. The communications score is a function of bandwidth, power remaining, past reliability and history, and other factors associated with the source device and destination device/WiFi sink in a potential route. In another arrangement, a device chooses a WiFi sink having known favorable policies (e.g., prioritization devices having certain characteristics, an ability to allow devices to pay more for higher priority access, and the like). In still other arrangements, the device chooses a WiFi sink based on a combination of a link metric and the WiFi sink's policies. In an alternative arrangement, the WiFi sinks may be cellular basestations or a combination of cellular basestations and WiFi hotspots. In some arrangements, multiple WiFi sinks are operated or managed by a single company or entity. In this case, a given mobile device maintains a single account balance with respect to all of the WiFi sinks operated or managed by the company.

Generally, each mobile device pictured in FIG. 1 has an alternative line cellular-based connection to a base station. Thus, if it is economically or practically more feasible for a node to communicate via a traditional cellular connection, it is able to do so. For example, the cost to use a new WiFi sink or set of WiFi sinks may be exorbitant or there may not be any WiFi sinks with sufficient connection quality in the vicinity of a given mobile device.

In some arrangements, software and hardware present in the WiFi sinks may allow for user transparent handover between WiFi sinks as the user traverses a geographic area (whether on foot, motorized vehicle, or through other means). In some arrangements, this handover is performed only between WiFi sinks that are under common operation, management, or contractual relation, while in other arrangements, handover is performed between “unrelated” WiFi sinks.

Consider next the owner or operator of a WiFi sink. The protocols used to grant, deny, and/or prioritize device access to a WiFi sink may be customized by its owner. This results in a competition as owners of WiFi sinks seek to customize their “access policies” to attract devices (i.e., customers) to their WiFi sink and increase the average spend per customer in relation to their WiFi sink. For example, in an attempt to attract devices, a WiFi sink owner may deprioritize (or deny access) to devices with poor community reputations (e.g., those that transmit too much and therefore have a reputation for causing interference to other device), those that consume disproportionately large bandwidth, and the like.

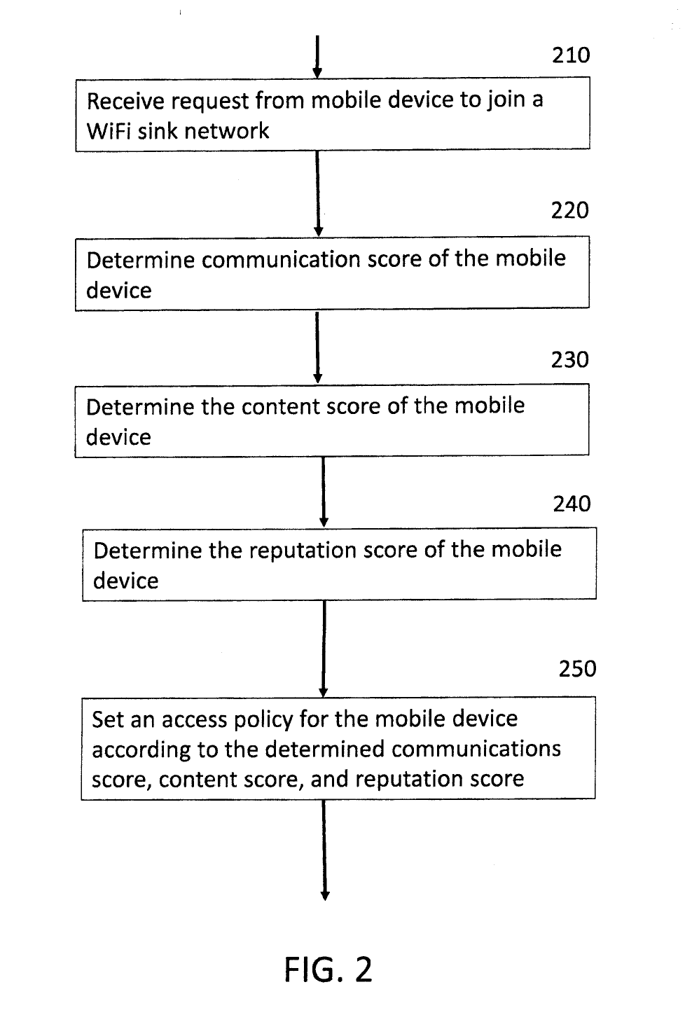

FIG. 2 depicts an illustrative process in which a WiFi sink operator sets an access policy for a mobile device to participate in a WiFi sink network in accordance with an embodiment. At 210, a given WiFi sink in the operator's network receives a request from a mobile device to join the network. This request could be in the form of a discovery message or any other suitable form of request. At 220, the WiFi sink operator's computer system determines a communications score of the mobile device. The communications score generally indicates the relative value of the mobile device in forwarding other mobile device messages and the relative burden on the network when the mobile device receives its own messages. A higher communications score generally indicates that the node is more critical to maintain the network topology infrastructure. For example, a high communications score will be given to nodes that are uniquely positioned to forward other nodes data (i.e., no other mobile device exist within the immediate area that are also able to forward data). The communications score will also be higher for mobile devices are stationary or slow moving, as these nodes will be able to more reliable serve the network. Thirdly, the communications score will be higher for nodes that have a high expected lifetime when battery operated, as these nodes will also be able to more reliably serve the network. The communications score may be a numerical value on a scale from 1 to 100, or an equivalent.

At 230, the WiFi sink operator's computer system determines a content score of the mobile device. The content score indicates how much the type of data that the mobile device intends to transmit will burden network resources. The content score depends on one or more of latency properties of the data, throughput properties of the data, and a burstiness of the data. Generally, mobile devices transmitting content with stringent latency requirements (e.g., streaming video or music) are assessed lower communications scores. Similarly, mobile devices transmitting content with high average throughput requirements (e.g., large bit torrent files) are assessed lower communications scores. Finally, mobile devices transmitting data that is bursty in nature (e.g., audio captured from a source that makes only intermittent noise) are assessed lower communications scores. The content score may be a numerical value on a scale from 1 to 100, or an equivalent.

At 240, the WiFi sink operator's computer system determines a reputation score of the mobile device. The reputation score may indicate whether the device has been “flagged” or banned in the operator's own network or in any other network that the operator has access to the relevant information of. In one arrangement, a number WiFi sink operators agree to share such reputation information with each other, e.g., through a third-party intermediary. In some arrangements, a mobile devices reputation score in a binary number (e.g., a score of 0 indicates that the mobile device has a good reputation and a score 1 indicates that the mobile device has a bad reputation) while in other the reputation score is set from a range of numbers, e.g., from 1 to 100, with a higher number indicating a better reputation.

At 250, the computing system of the WiFi sink operator sets an access policy for the mobile device according to the determined communications score (at 220), content score (at 230), and reputation score (at 240). In some arrangements, the access policy is “all of none,” meaning that that the WiFi sink operator makes a decision to either allow the mobile device on the network or not based on an analysis of the combined communications score, content score, and reputation score. For example, these three scores may be summed and compared to a threshold to make the “all or none” decision.

In some arrangements, even if the mobile device is allowed to access the network based on the communications score, content score, and reputation score, the WiFi sink operator sets an access policy based on these three underlying scores. For example, a device with a poor reputation score may be carefully monitored and “kicked off” the WiFi network if selfish or malicious behavior is detected. As another example, a device with a high communications score may be encouraged to participate in the network by being awarded an unlimited throughput quota and by having its data stream prioritized over other users with lower communications scores. As yet another example, a device with a low content score may have its data prioritized over devices with higher content scores under the rationale that if all devices receive data sufficient timely relative to their individual requirements, the network WiFi sink operator stands to make more revenue.

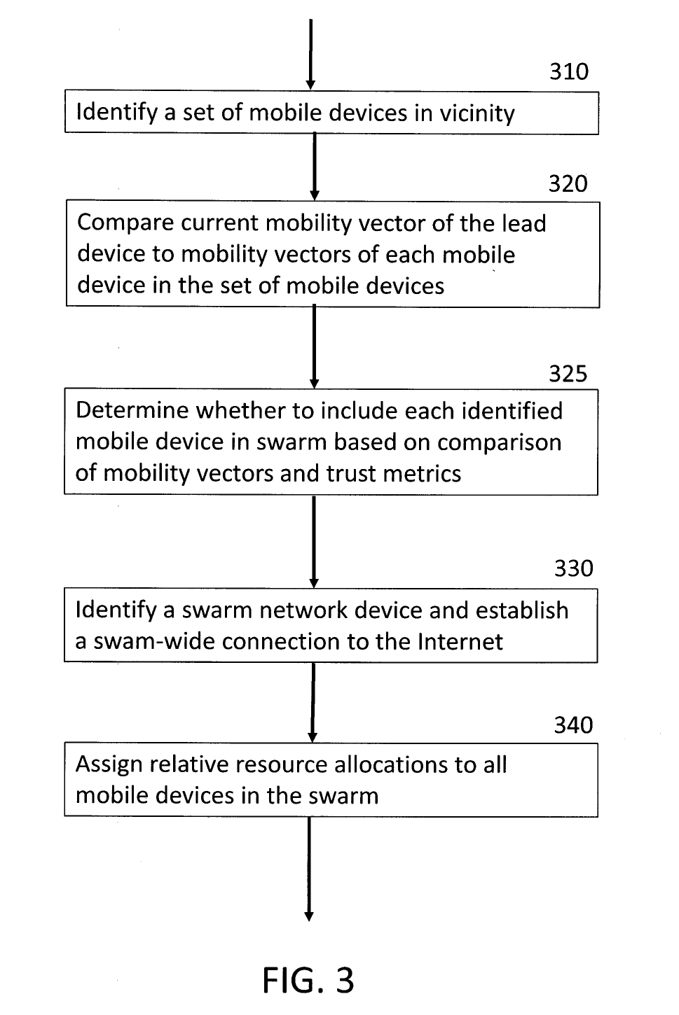

FIG. 3 depicts an illustrative process for establishing swarm-based mobile communications in accordance with an embodiment. In arrangements, some or all of the functions of the process 300 are executed by a mobile device located within a group of mobile devices. This mobile device will be referred to as the “lead mobile device” for clarity of presentation only.

At 310, the lead mobile device identifies other mobile devices in its vicinity. In some arrangements, the lead mobile device sends broadcast messages and requests that any mobile device that receives a broadcast message reply with its identity. In some arrangements, the lead mobile device contacts a remote server which tracks positions of a wide number of mobile devices. The lead mobile device receives from the remote server a list of mobile devices in vicinity of the lead device.

At 320, the lead mobile device being a function of determine whether any of the mobile devices in the set of mobile devices are suitable for being included in a swarm of devices that is managed by the lead mobile device. To do so, the lead mobile device determines a mobility vector associated with each mobile device in the set of mobile devices. The mobile vector includes information on a speed and a direction in which that mobile device is moving. Also at 320, the mobile device compares its own mobility vector with the mobility vector of each mobile device in the set of mobile devices and calculates a “mobility difference” with respect to each mobile device in the set of mobile devices.

In arrangements, the mobility difference is a score from 1 to 100, that indicates how far away a given mobile device is expected to be from the lead mobile device at some point in the future. In these arrangements, a score 1 indicates that the lead mobile device and the given mobile device are relative stationary with respect to each other, while a score of 100 indicates that the lead mobile device and the given mobile device moving rapidly apart from each other. In some arrangements, the mobility difference is a two coordinate vector that, for each mobile device in the set of mobile devices, indicates a velocity difference and a directional difference (e.g., expressed in radians) between the lead mobile device and the given mobile device.

At 325, the lead mobile device determines whether to include each identified mobile device in a swam that it coordinates based on (a) the comparison of mobility vectors obtained at 320 and (b) one or more trust metrics. The analysis performed by the lead mobile devices starts with (a). In some arrangements, the degree of difference between the mobility vector of the lead mobile device and a given mobile device in the set of mobile devices is compared to a threshold. For example, using the example above, the numerical score of 1 to 100 may be compared to a threshold value of 50. If the threshold is exceeded, then the mobile device is excluded from the swarm. On the other hand, mobile devices that “pass” the threshold test will be included in the lead mobile device's swarm if they are deemed trustworthy according to one or more trust metrics.

In some arrangements, the lead mobile device determines the “trustworthiness” of a given mobile device that passed the mobility vector test by querying a third-party database that starts trust information on mobile devices. In other arrangements, the lead mobile device determines the trustworthiness of a given mobile device by accessing a local database that characterizes past behaviors of that mobile device. If the mobile device is deemed to be sufficiently trustworthy by the lead mobile terminal, and if its mobility vector is sufficiently close to the lead mobile terminals mobility vector, then the lead mobile terminal includes the mobile terminal in its swarm. In this way, the lead mobile terminal selects a group of nearby nodes to be included in a swarm that it manages.

Next, the lead mobile device determines which of the mobile devices in the swarm should provide a network connection for all other devices in the swarm. To do so, the lead mobile pings every other device in the swarm to determine a throughput of that device's network condition. The lead mobile device then identifies as a “swarm network device” that device which has the “best” network connection. The lead mobile device may make the determination of what constitutes the “best” network connection based on throughput, remaining battery life, latency, a measure of past reliability, or through any combination of these and other factors. The lead mobile device information the swarm network device of its status via one or more messages sent to the swarm network device.

The swarm network device acts as a funnel of data to and from a network. In particular, the swarm network device receives data from the network on behalf of all swarm members and transmits data to the network on behalf of all swarm members. To forward data to nodes in the swarm, and receive data from nodes in the swarm, the swarm network devices establishes a mobile-to-mobile connection to all devices in the swarm. This mobile-to-mobile connection may be a cellular based connection (e.g., LTE direct), a WiFi connection, or vehicle-to-vehicle based connection. The described communications hierarchy reduces communications overhead (particularly with respect to power transmission and spectrum pollution) as compared to traditional approaches. First, a large number of device to network connections are replaced with a single connection and a number of (relatively) low-power mobile-to-mobile connections. Second, it is not the case that every pair of devices in the swarm need to have mobile-to-mobile connections. Rather, it is only required that the swarm network device have a mobile-to-mobile connection with every other mobile device in the network.

At 340, either the lead mobile device or the swarm network device allocates communications resource to all mobile devices in the swarm. This allocation may be based on an amount that each device is willing to pay collectively to members of the swarm or any other suitable metric. The communications resources allocated at 340 may include one or more of throughput, latency reduction, or a number of communications channels (particularly if a channelized communications protocol, such as OFDM, is used in mobile-to-mobile connections of the swarm). The swarm configuration is especially advantageous for passing information on real-time events among swarm members. For example, in the case where the swarm corresponds to vehicles on the road, observations on accidents, traffic conditions, and the like may efficiently be passed among swarm members using the described communications technology.

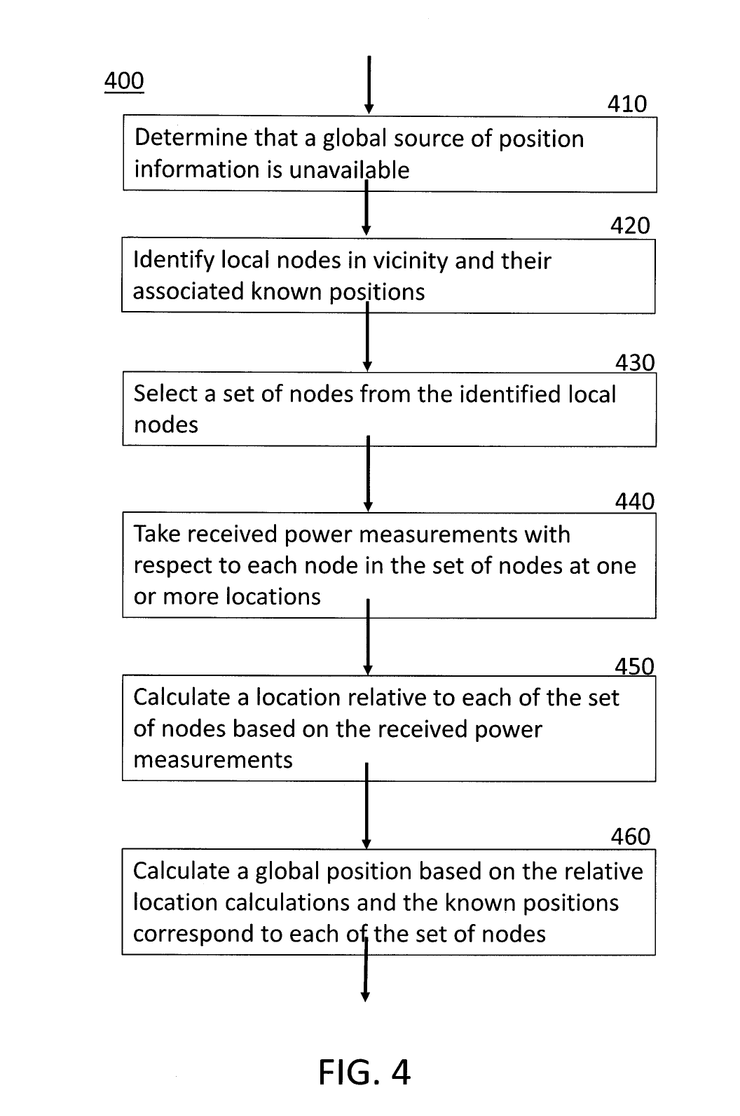

FIG. 4 depicts an illustrative localization-based process for determining a position of a radio node through received signal power measurements in accordance with an embodiment. In arrangements, most or all of functionality of the process 400 is run by software executing on a mobile device, which may be, e.g., a mobile phone (e.g., a smartphone), tablet, navigation system, laptop, portable digital assistant (PDA), or smart watch device. For clarity of presentation only, and not for limitation, it will be assumed in the following description that a mobile phone performs the process 400.

A mobile phone typically derives or receives position information from a “global” source, e.g., from GPS signals or a signal from a cellular base station (a “global” source need not be available anywhere in the world as the term merely signifies a usual or primary signal from which a mobile phone derives location information). At 410, it is determined that a global source of position information is unavailable. There are a large number of reasons why the global source of position information may be unavailable. For example, GPS location may not be available when a phone is located indoors, underground, in an area with significant obstructions, in an area with limited cellular coverage, and/or in a part of the world with insufficient communications to an adequate number of GPS satellites.

The mobile phone may determine that the global source of position information is unavailable using any suitable technique. In arrangements, the mobile phone makes this determination after a specified time interval passes without the mobile phone having received a “beacon” signal from the global source. In arrangements, the mobile phone makes this determination if the global source fails to respond to a query message issued by the mobile phone.

At 420, local nodes in vicinity of the mobile phone and their associated positions are identified. In the absence of a global source of position information, the mobile phone turns next to “nodes” in its vicinity. In particular, at 420, the mobile phone identifies nodes in its vicinity that are likely to have known position information available and a willingness to share that position information with the mobile phone. Nodes may correspond to “fixed” infrastructure, such as a WiFi router, femtocell, or emergency beacon, or to other mobile devices, such as tablets, other mobile phones, and laptops.

The mobile phone issues a query to nodes in its vicinity using a mobile-to-mobile communications protocol. This protocol may be a cellular based mobile-to-mobile protocol, such as LTE direct, a WiFi protocol, or a Bluetooth based protocol. At 420, the mobile phone identifies local nodes in its vicinity based on reply messages received from those nodes in response to its query. Each reply message contains the fixed and known position (e.g., specified in the format of GPS coordinates) of the node that sends the messages. Thus, at 420, the mobile phone is able to identify local nodes in its vicinity and their associated known positions.

At 430, the mobile phone selects a set of nodes from the identified local nodes. The mobile phone may, of course, selected all of the identified local nodes, but typically does not for two reasons. First, the accuracy of the localization technique to be performed by the mobile phone may quickly diminish in a number of selected nodes. Second, computational complexity and a time required to perform localization may increase rapidly in the number of selected nodes. In some arrangements, some or all of the local nodes identified at 420 may charge for transmission of their cooperation and so the mobile device may select only a few lost-cost cooperators who may additionally be located in relatively different locations with respect to each other (i.e., to improve an accuracy of the localization technique described herein).

At 440, the mobile phone takes received power measurements with respect to each node in the set of nodes at one or more locations. In particular, the mobile terminal moves to a first location. At this first location, the mobile phone transmits a certain query message to each node in the selected set of nodes. In response to the query message, each node in the selected set of nodes transmits a beacon message. The mobile phone may know the initial power with which a given node transmits the beacon message (e.g., this information may be included in the beacon message itself or in the initial communications between the mobile phone and the node) or the mobile phone may not have this information. In either case, the phone records, for each node in the set of selected nodes, a power with which each beacon message is received. Once this process is complete, the mobile phone moves to a second location and again transmits the same type of certain query message to each node in the selected set of nodes. In response to this second query message, each node in the selected set of nodes again transmits a beacon message. The mobile phone again records, for each node in the set of selected nodes, a power with which each beacon message is received. This process continues for a set of up to N movements of the mobile phone, where N is a positive integer (1, 2, 3, . . . ). In arrangements, a value of the parameter N is selected based on one or more of a time-sensitivity with which a location is needed, a desired computational complexity, and a total cost for acquiring cooperation of the selected set of nodes over repeated beacon transmission 450, a location relative to each of the set of nodes is calculated based on the received power measurements. In particular, the mobile phone determines a three-dimensional distance from each node in the selected set of nodes based on the received signal strengths results obtained at 440. The results may be obtained through any suitable function or algorithm. For example, in an arrangement, the mobile phone effectively plots a histogram of signal strength values versus its own position based on data received from a given local node and, form the histogram, uses one or more interpolation techniques known in the art to determine its estimated relative location to the node. The relative locations to each node calculated by the mobile phone at 440 may be specified in terms of a GPS coordinate vector, a 3-dimensions Cartesian distance vector, or in any other suitable form or representation.

At 460, the mobile phone calculates a global position based on the relative location calculations and the known positions corresponding to each node in the selected set of nodes obtained at 450. To do use, the mobile phone uses one or more triangulation techniques that are known in the art. Further, in arrangements, the mobile phone may first compute a global location using only some of the relative locations and known positions obtained at 450 and then may various, skew, or otherwise adjust these results, based on other ones of the relative locations and known positions obtained at 450.

Thus, the disclosure relates to localization-based techniques for determining a position of a radio node through received signal power measurements in accordance with an embodiment. The disclosed techniques enable a mobile phone to determine its 3-dimensional location from messages passed and received from neighboring nodes in its vicinity rather than in reliance on a global location signal (e.g., a GPS signal).

A VIP radio in radio network is a radio that demands large amounts of one or more communications resources (e.g., bandwidth, authority to transmit with large transmission power, low latency, etc.) and that is willing to pay for such resources (provided that the resources are available). A VIP radio is typically one that is operated by a wealthy or price-indifferent user. A VIP radio is generally wireless, but may also be wired. A VIP radio may, among other devices, a smartphone, tablet, laptop computer, or portable digital assistance (PDA).

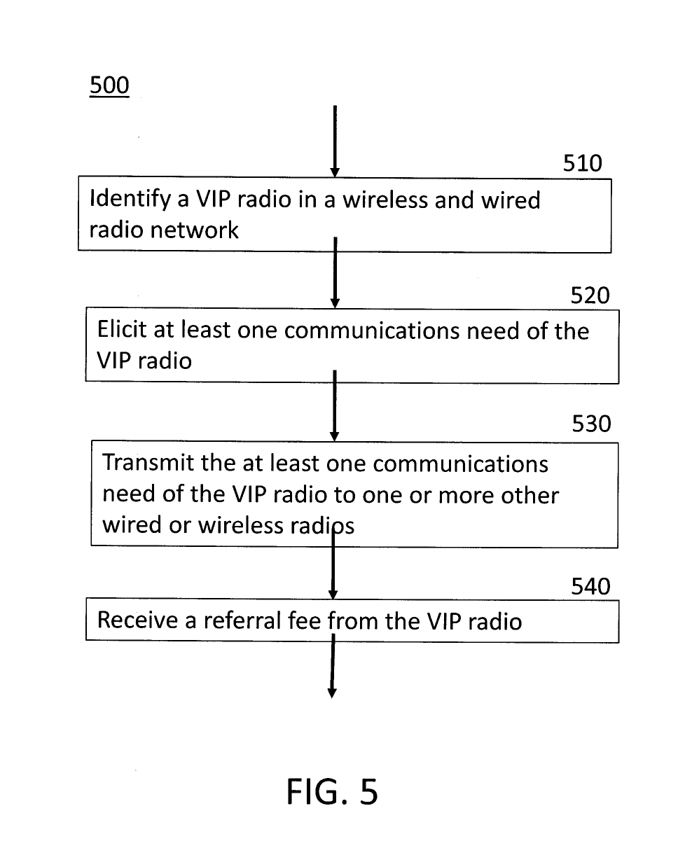

FIG. 5 depicts an illustrative process for allocating resources among radios in a wireless radio network according to communications needs and price sensitivity in accordance with an embodiment. In arrangements, the process 500 is executed by a “bystander” wireless radio in a radio network (i.e., a wireless radio other than a VIP radio). At 510, a VIP radio in a radio network is identified by a bystander radio in the network. In some arrangements, the bystander radio identifies the VIP nodes by passively observing transactions that the VIP enters into and determining that the VIP node (a) demands significant communications resources and (b) is willing to pay for the additional resources. In some arrangements, the network infrastructure transmits identifying information of the VIP node to the bystander nodes. In some arrangements, the VIP node “announces” its presence to the other radios in the network by regularly transmitting broadcast messages identifying itself as a VIP node.

At 520, at least one communications need of the identified VIP node is elicited by the bystander node. In some arrangements, the bystander node transmits a query to the VIP node requesting that the VIP node identify a communications requirement. In some arrangements, the bystander node observes a pattern in the VIP node's requests and infers a communications need of the VIP node. Potential communications needs of a VIP node include throughout, reduced latency, or in channelized system (e.g., multi-carrier based systems), a number of communications channels.

At 530, the at least one communications need of the VIP radio is transmitted to one or more other “secondary” (wired or wireless) radios who may have excess resources to provide to the VIP node. In some arrangements, this communications from the VIP radio to the one or more secondary radios is performed using a mobile-to-mobile communications link (e.g., an LTE link or a WiFi communications link). In some arrangements, this communications is routed through a cellular network infrastructure between the bystander nodes and the one or more secondary nodes.

At 540, a referral fee is received by the bystander node from the VIP radio. The referral fee may be based on an amount of resources that the bystander nodes referred to the VIP radio and pricing may be set based on a real-time electronic marketplace for various communications resources. In some arrangements, any of the one or more secondary nodes may itself act as a bystander node by forwarding messages to other adjacent radios.

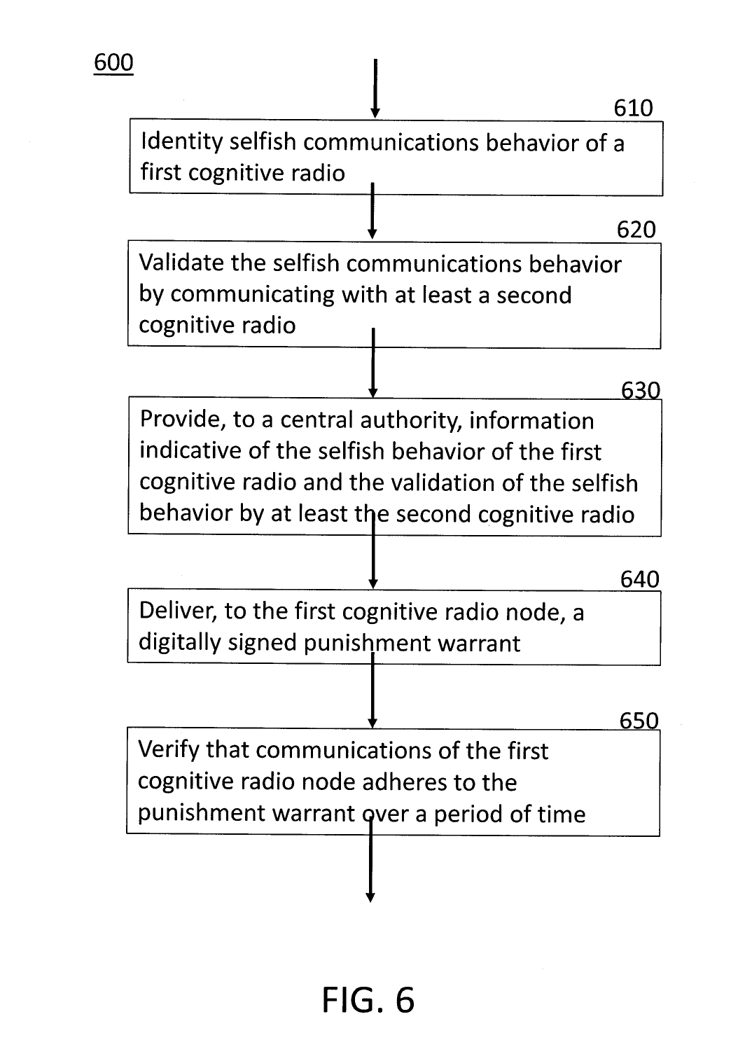

FIG. 6 depicts an illustrative process for identifying and penalizing selfish or malicious behavior of a radio in a cognitive radio network in accordance with an embodiment. In arrangements, most or all of the functionality described in relation to 610, 620, and 630 and optionally 650 of the process 600 is performed by software executing on a device, which may be, e.g., a mobile phone (e.g., a smartphone), tablet, navigation system, laptop, portable digital assistant (PDA), or smart watch device. The device need not be a cognitive radio although it may be. In arrangements, most or all the functionality described in relation to 640 is performed by a central management authorize, which includes software running a server located remotely from the cognitive radio network. For clarity of presentation only, and not for limitation, it will be assumed in the following description that a mobile phone performs the functionality described in relation to 610, 620, and 630 and 650 of the process 600 and that a remote server running software performs the functionality described in relation to 640 of the process 600.

At 610, a mobile phone identifies what it believes to be selfish communications behavior in a first cognitive radio. The mobile phone and the first cognitive radio may be a part of the same or different communications networks. However, the mobile phone makes such an identification by listening to transmission and detecting “suspicious” transmission on the part of the first cognitive radio. The identification of suspicious behavior may be based on the mobile phone's detection of one or more of the following: (a) that the first cognitive radio is transmitting with an unusually large amount of transmission power, (b) that the first cognitive radio is not “taking breaks” or adhering to “silent periods” in its communications, (c) that the first cognitive radio begins its own transmissions even when another node in its vicinity is already transmitting, and (d) that the first cognitive radio is engaged in jamming the communications of other nodes.

At 620, the mobile phone validates the perceived selfish communications behavior of the first cognitive radio by communicating with at least a second cognitive radio in the network. In some arrangements, to perform this corroboration, the mobile phone may send a query message to the second cognitive radio describing a nature of the suspicious behavior at ask the second cognitive radio to independently confirm and report back as to whether the second cognitive radio also observes that behavior. In these arrangements, the mobile phone will proceed to 630 if the report back confirms the suspicious behavior. Otherwise, the mobile phone may poll one or more additional cognitive radios or discard its effort.

In arrangements, the mobile phone may send query messages to a plurality of cognitive radios in or out of the network (other than the first cognitive radio) and wait for responses for each of the cognitive radios describing whether that cognitive radio is able to confirm the suspected suspicious behavior of the first cognitive radio. In these arrangements, the mobile phone may take a “majority” vote as to the observations of the other cognitive radios to determine whether to proceed with an action against the first cognitive radio. If the mobile phone does proceed with an action, the process 600 proceeds to 630. The communications between the mobile phone and the plurality of cognitive radios in or out of the network (other than the first cognitive radio) are based upon any suitable mobile-to-mobile communications protocol. For example, a cellular-based protocol (e.g., LTE Direct), WiFi protocol, or Bluetooth protocol may be used.

At 630, the mobile phone provides, to a central authority, information indicative of the selfish behavior of the first cognitive radio and the validation of the selfish behavior by at least a second cognitive radio (both obtained at 620). The mobile phone transmits this information to the central authority using a cellular or mobile-to-mobile connection. In some arrangements, the information provided to the central authority includes one or more of: (i) a qualitative label describing the selfish behavior, (ii) a unique identification of cognitive radios which validated the selfish behavior at 630, (iii) a unique identification of cognitive radio which were attempted to but were not able to validate the selfish behavior at 630 (if any), and (iv) a unique identification of the first cognitive radio. The central authority may then use some or all of the information in (i) through (iv) to contact the implicated cognitive radios with any additional queries for information. Provided that the central authority is sufficiently satisfied that the first cognitive radio has indeed engaged in selfish behavior, the process 600 proceeds to 640.

At 640, a digitally signed punishment warrant to the first cognitive radio. In some arrangements, the central authority itself transmits the warrant to the first cognitive radio. In some arrangements, the central authority transmits the warrant instead to the mobile, whom then transmits the warrant to the first cognitive radio. In some arrangements, the central authority authorizes the mobile phone to generate a digital warrant and transmit it to the first cognitive radio. In any of these arrangements, the first cognitive radio receives the digital warrant and abides by a “punishment” disclosed in the warrant.

In particular, each cognitive radio is fitted with an “enforcement” chip at a factory. Upon reading a valid digitally-signed punishment warrant, this enforcement chip overrides any type of communications behavior that the cognitive radio may be engaged in (e.g., despite the commands of a user of the cognitive radio). The types of punishment specified by the digitally-signed punishment warrant vary. For example, punishment could comprise one or more of the following: (a) staying silent (i.e., not transmitting voice or IP-based data) for a specified period of time, (b) providing payment to the central authority, (c) providing payment to one or more other cognitive or non-cognitive radios in the network, (d) being barred from any participation or activity on the network for a limited period of time and/or until a suitable fine is paid.

At 650, the mobile phone (and/or the central authority) verifies that the first cognitive radio adheres to the terms of the punishment warrant. In most situation, the first cognitive radio will adhere to the terms based on the enforcement chip described above. However, in rare cases, it is possible that the enforcement chip could be hacked or otherwise malfunctioning. In these cases, if continued selfish or malicious behavior is detected by the first cognitive radio in violation of the terms of its punishment warrant, additional action may be taken against the first cognitive radio. For example, the central authority may remotely shut down any ability of the first cognitive radio to use its transmitter. As another example, the central authority may dispatch one or more persons (e.g., enforcement technicians) to investigate the selfish or malicious behavior by taking to an owner of the first cognitive radio.

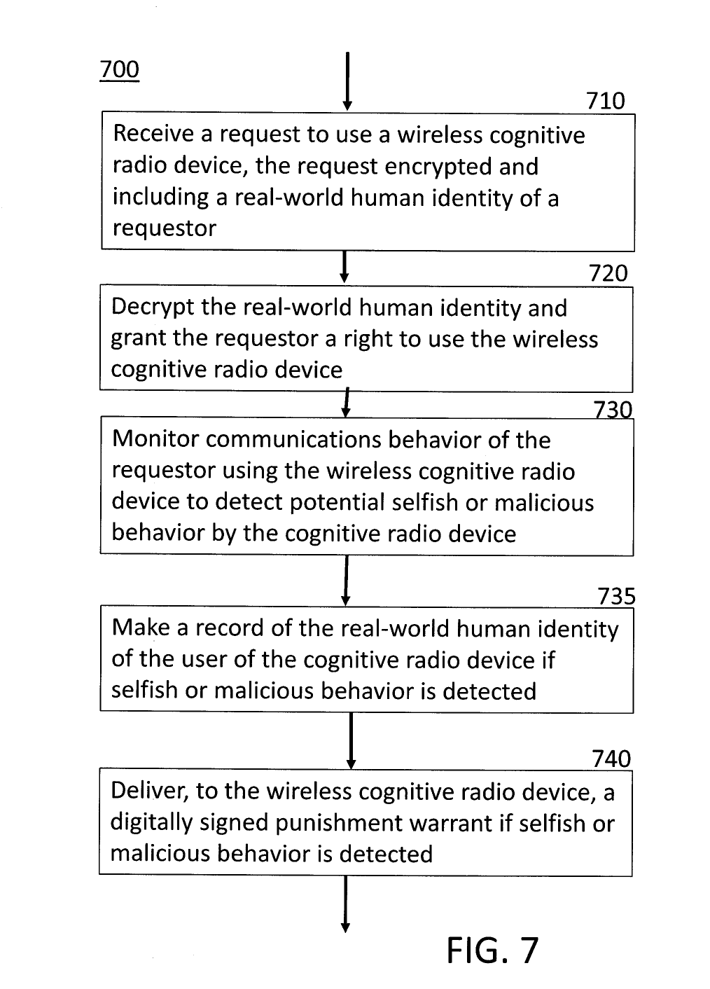

FIG. 7 depicts an illustrative process for identifying and penalizing selfish or malicious behavior of a radio in a cognitive radio network in accordance with an embodiment. In arrangements, most or all of the functionality described in relation to 710, 720, 730, and 740 of the process 700 is performed by a central management authority, i.e., software executing on a server remote to a cognitive radio network. The cognitive radio network may include a heterogeneous mix of devices. For example, the cognitive radio network may include one or more mobile phones (e.g., smartphones), tablets, navigation systems, laptops, portable digital assistants (PDAs), or smart watch devices. For clarity of presentation only, and not for limitation, it will be assumed in the following description that the central management authority performs the functionality described in relation to 710, 720, and 730 and 740 of the process 700.

At 770, the central management authority receives a request to use a wireless cognitive radio device. In particular, the request is from a person who desires to use a cognitive radio phone that they may have recently purchased, borrowed, rented, or “reset.” Before allowing the user to use the desired cognitive radio device, the central management authority must determine a real-world human identity of the user (so that there is accountability in case the user's use of the cognitive radio is malicious or selfish with respect to other users). In some arrangements, the real-world human identity corresponds to a United States social security number, a federal tax ID number, or a driver's license number. Accordingly, the request received at 710 includes, in encrypted form, information identifying the requestor in real-world terms.

At 720, the central management authority decrypts the request received at 710 to determine the real-world identity of the person who made the request for use of a cognitive radio. Provided that the real-world identity is not associated with any past violations or unresolved “suspect” behavior with relation to using cognitive radios, the central management authority grants the requestor a right to use the wireless cognitive radio device. Further at 720, the central management authority associates the real-world identity of the person using a given cognitive radio device with a unique ID for the cognitive radio device. In arrangements, this association is made by updating entries in a corresponding database.

At 730, the central management authority monitors the communications behavior of the cognitive radio device for which use was granted at 720 to detect potential selfish or malicious behavior by the cognitive radio device. In some arrangements, the central management authority monitors for such behavior directly. In some arrangements, the central management authority tasks one or more mobile phones in vicinity of the cognitive radio device to perform the monitoring and report back to the central management authority on any observed selfish or malicious behavior.

Selfish or malicious behavior comprises a wide variety of communications behaviors. In arrangements, identification of selfish or malicious behavior may involve detecting one or more of the following: (a) that the cognitive radio device is transmitting with an unusually large amount of transmission power, (b) that the cognitive radio device is not “taking breaks” or adhering to “silent periods” in its communications, (c) that the cognitive radio device begins its own transmissions even when another node in its vicinity is already transmitting, and (d) that the cognitive radio device is engaged in jamming the communications of other nodes.

If selfish or malicious behavior is detected, the central management authority acquires the following information (either directly or through a tasked mobile device): (i) a qualitative label describing the selfish or malicious behavior, (ii) and the unique identification of cognitive radio cognitive radio device that engaged in the selfish or malicious behavior.

At 735, a record of the real-world human identity of the user of the cognitive radio device is recorded if selfish or malicious behavior is detected. In this way, people who have a history of selfish or malicious use of cognitive radios devices can be tracked, even as they attempt to move from one cognitive radio device to another. The requirement that use of a cognitive radio device be predicated on a real-world human identity of the requestor thus ensures security and negative consequences for bad actors. In arrangements, the central management authority reports the real-world human identity of a user who engages in selfish or malicious behavior to a governmental agency and/or a third-party reputation management service. In these cases the ill-acting user cannot escape consequences of their behavior simply by switching to another providers cognitive radio devices, as long as that provider also coordinates with the governmental agency or third-party reputation management service to share information on users.

At 740, a digitally signed punishment warrant is delivered to the wireless cognitive radio device. In some arrangements, the central authority itself transmits the warrant to the first cognitive radio. In some arrangements, the central authority transmits the warrant instead to an intermediary wireless device, whom then transmits the warrant to the cognitive radio device. In some arrangements, the central management authority authorizes the intermediary mobile phone to generate a digital warrant and transmit it to the first cognitive radio. In any of these arrangements, the cognitive radio device receives the digital warrant and abides by a “punishment” disclosed in the warrant.

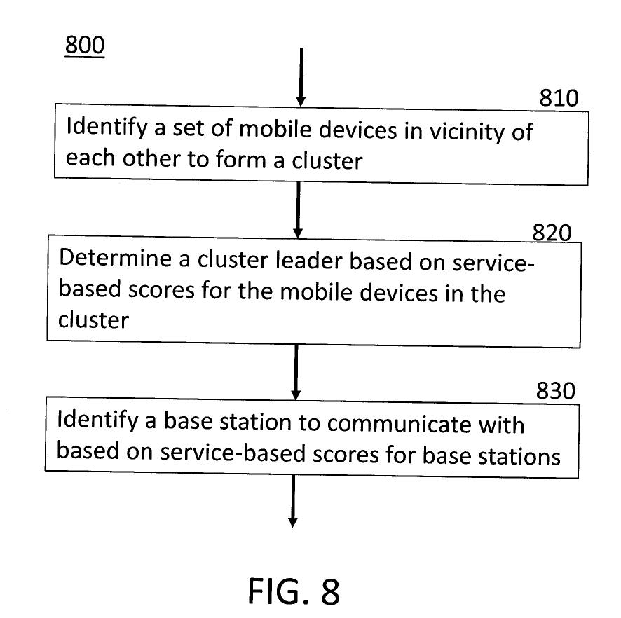

FIG. 8 depicts an illustrative process for establishing a communications hierarchy in a cognitive radio network in accordance with an embodiment. At 810, a set of mobile devices within vicinity of each other are identified and agree to form a network cluster. In arrangements, the devices identify each other based on GPS coordinates. In particular, all devices located within a given region (as defined by GPS coordinate boundaries) are associated with a fixed cluster.

At 820, a cluster leader, i.e., a node that sends messages to a base station and that receives data from the base station on behalf of all nodes in the cluster, is determined based on service-based scores for all the mobile devices in the cluster. In particular, there exists a third-party subscription service. All nodes in the cluster subscribe to this service. The service maintains information the “score” of each node within a cluster. The score reflects criteria relevant to choosing a leader among the nodes in the cluster. For example, the service could maintain the information needed to compute the Klout score, communications score, reputation score, and or any other type of score for each of the nodes in the cluster. Using data from this third-party service, all nodes agree as to which node in the cluster will act as a leader node (therefore, the service serves not only as a repository for data, but also as an arbitrator that all nodes have in effect agreed in advance has the authority to set a cluster leader based on the scores maintained by the service. Nodes agree to provide information to the service that the service needs to compute nodes scores in exchange for being able to participate in the cluster.

At 830, a base station is identified for the cluster leader to communicate with based on the service-based scores for the base stations. Here again, nodes of a cluster rely on the data provided by the third-party service. For example, the service may collect and store information as to the reliability and communications quality associated with each base station. The service may do this by sending and receiving “dummy’ information from each base station in a way that the transparent to the base station telecommunications provider. Additionally or alternatively, the dummy service may rank base station “quality” by passively monitoring/noting how often the base station is available, any frequency of any outages, and other parameters that are easily observable without necessarily “tricking” or sending dummy info through the base station. The service may maintain such data averaged over time and history.

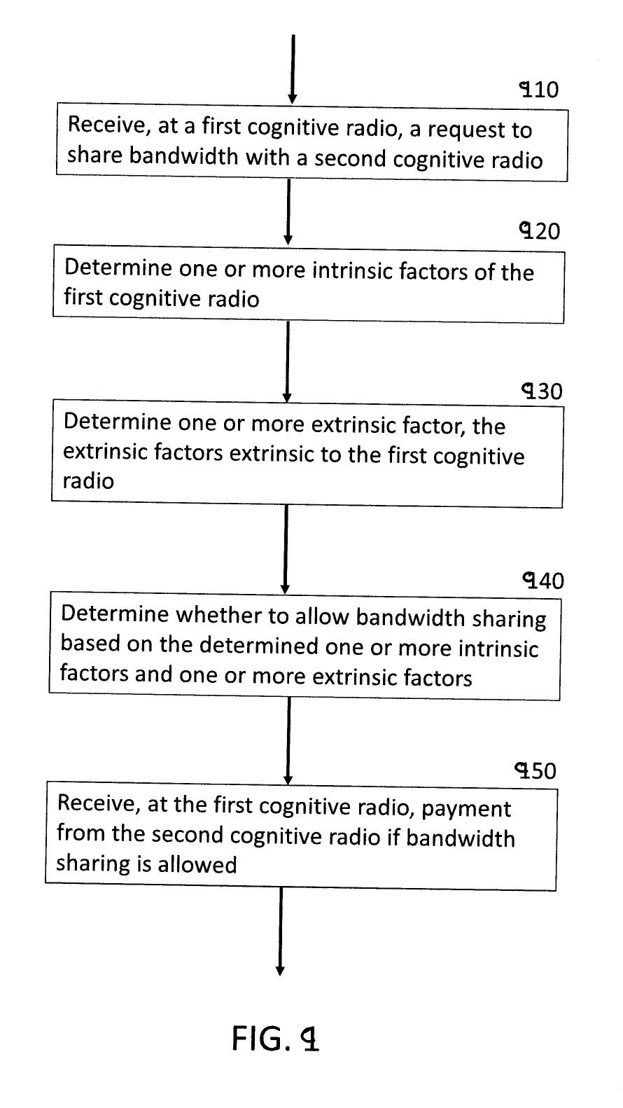

FIG. 9 depicts an illustrative process for enabling an automatic sharing of bandwidth between cognitive radios in accordance with an embodiment. In arrangements, most or all of functionality of the process 900 is run by software executing on a cognitive radio device (“cognitive radio”), which may be, e.g., a mobile phone (e.g., a smartphone), tablet, navigation system, laptop, portable digital assistant (PDA), or smart watch device. For clarity of presentation only, and not for limitation, it will be assumed in the following description that a cognitive radio performs the process 900.

At 910, a first cognitive radio receives a request from a second cognitive radio to share bandwidth with the second cognitive. The request may be received via a network infrastructure (e.g., cellular or WiFi) or from a mobile-to-mobile connection (e.g., an LTE direct connection). The request to share bandwidth may additionally specify a nature of the bandwidth sharing. For example, the request may specify that the second cognitive radio wishes to use the first cognitive radio as a relay to an access point. As another example, the request may specify that the second cognitive radio wishes to use time slots or orthogonal channels initially reserved for the first cognitive radio.

At 920, in response to the request received at 990, the first cognitive radio determines one or more intrinsic factors. Intrinsic factors refer to data or information directly and unambiguously accessible from the first cognitive that aid the first cognitive radio in making an automatic determination on whether to allow the second cognitive radio to share bandwidth of the first cognitive radio. At 990, the first cognitive radio may automatically determine one or more of:

(9) A battery level of the first cognitive radio and whether the first cognitive radio is connected to a permanent power source (e.g., a wall outlet). Bandwidth sharing with the second cognitive radio may consume power resources of the first cognitive radio and so the first cognitive radio is more likely to allow bandwidth sharing if it has a large battery reserve or if it is connected to a permanent power source.

(2) Portion of bandwidth currently in use. The first cognitive radio is more likely to allow bandwidth sharing if it is currently using only a small amount of its own available bandwidth. Accordingly, the first cognitive radio may determine a portion of its own bandwidth currently in use.

(3) Application-specific requirements of an in-use app. Some applications may not be consuming large amounts of bandwidth at the exact time that the request at 990 is received but, by their nature, may generate or receive bursty traffic, meaning that they may predictably consume large amounts of bandwidth at a later time. Therefore, the first cognitive radio may examine applications in use to determine if any of them are likely to require large amounts of bandwidth at a later time. As part of this determination, the first cognitive radio may also determine whether any application has strict latency and/or QoS requirements (i.e., as opposed to best service requirements). Generally, the first cognitive radio will be more likely to share bandwidth if the applications that it is running are non-bursty and if they are governed by best efforts requirements.

At 930, also in response to the request received at 990, the first cognitive radio determines one or more extrinsic factors. Extrinsic factors refer to data or information that is retrieved from sources extrinsic to the first cognitive radio and/or that are inherently ambiguous (e.g., that involve prediction of future events). Determination of extrinsic factors by the first cognitive radio aids the first cognitive radio in making an automatic determination on whether to allow the second cognitive radio to share bandwidth of the first cognitive radio. At 920, the first cognitive radio may automatically determine one or more of:

(1) Reputation of the second cognitive radio. The first cognitive radio may determine a “reputation” of the second cognitive radio for engaging in malicious or selfish behavior, or for failing to pay for bandwidth sharing in past instances. To do so, the first cognitive radio may poll a third-party reputation management service for cognitive radios. The worse the reputation of the second cognitive radio, the less likely it is that the first cognitive radio will allow bandwidth sharing.

(2) Monetary value of bandwidth sharing. The monetary compensation to the first cognitive radio for allowing the second cognitive radio to share bandwidth may be highly variable and depend on, inter alia, a time of day and week, a geographic location of the first cognitive radio, and a number of other potential collaborators available to the second cognitive radio. Accordingly, at 930, the first cognitive radio may determine an expected monetary compensation it will be awarded if it allows bandwidth sharing with the second cognitive radio.

(3) Prediction of connection disruption. Suppose that the first cognitive radio starts to share bandwidth with a second cognitive radio and that a connection between the first and second cognitive radios “breaks” or that the first cognitive radio becomes unable to access resources provided to it by the second cognitive radio that enable bandwidth sharing. In these cases, the first cognitive radio fails to fully collect on compensation that it would have otherwise been entitled to for bandwidth sharing. Accordingly, at 930, the first cognitive radio may make an assessment of how reliable a connection between it and the second cognitive radio is. This determination may be based on relatively mobility between the two radios (if they move physical apart, the connection will likely break), predicted movements of either the first or second cognitive radios based on historic movement patterns, and/or predictions as to network or resource outages. Generally, the more likely a connection disruption, the less likely it is that the first cognitive radio will share bandwidth with the second cognitive radio.

At 940, the first cognitive radio determines whether to allow bandwidth sharing with the second cognitive radio based on the one or more intrinsic factors (determined at 920) and the one or more extrinsic factors (determined at 930). In arrangements, the first cognitive radio assigns a numerical value between 0 and 900 to each of these determined factors and compares the overall score to a threshold value. If the overall score exceeds the threshold value, then bandwidth sharing with the second cognitive radio allowed. Otherwise, bandwidth sharing with the second cognitive radio is denied. At 950, the first cognitive radio receives payment from the second cognitive radio for any bandwidth sharing that was allowed. The payment may be made directly via a mobile-to-mobile connection or indirectly via a third party or telecommunications network service.

Although embodiments have been described in detail with reference to the accompanying drawings for the purpose of illustration and description, it is to be understood that the inventive processes and apparatus are not to be constructed as limited thereby. It will be apparent to those of ordinary skill in the art that various modifications to the foregoing embodiments may be made without departing from the scope of the invention.

1. A method for granting access to a mobile device on a network, the method comprising:
receiving an access request from a mobile device;
determining a communication score, a content score, and a reputation score associated with the mobile device; and
setting an access policy for the mobile device on the network based on at least one of the communications score, the content score, and the reputation score.

2. The method of claim 1, wherein the content score depends on a burstiness of data, an average throughput of data, and a latency requirement of data characteristic of the mobile device.

3. The method of claim 1, wherein determining the reputation score comprises:
contacting a server operated by a third-party organization;
providing an ID associated with the mobile device to the third party service; and
retrieving reputation information associated with the ID.

4. The method of claim 1, wherein setting the access policy comprises assigning a bandwidth or throughput limit to the mobile device based on the determined communications score associated with the mobile device.

5. The method of claim 1, wherein setting the access policy comprises barring the mobile device from the network if a sum of the communications score, the content score, and the reputation score is less than a threshold value.

6. A method for forming a mobile swarm, the method comprising:
identifying, at a lead device, a set of mobile devices in vicinity of the lead device;
comparing a mobility vector of the lead device to mobility vectors of each of the other mobile devices in the set of mobile devices; and
determining whether to include a given mobile device of the set of mobile devices in the swarm based on the comparing.

7. The method of claim 6 wherein determining whether to include a given mobile device of the set of mobile devices in the swarm is based on one or more trust metrics associated with the given mobile device.

8. The method of claim 6, further comprising identifying a swarm network device and establishing a swarm-wide connection to the Internet via the swarm network device.

9. The method of claim 8, wherein identifying the swarm network device comprises assessing a network bandwidth associated with the swarm network device.

10. The method of claim 6, further comprising assigning relative resource allocations to mobile devices in a swarm.

11. A method for allocating resources among radios in a wireless radio network, the method comprising:
identifying a VIP radio in a radio network;
eliciting at least one communications need of the VIP radio;
causing a transmission of the at least one communications need to one or more secondary radios; and
receiving a referral fee from the VIP radio.

12. The method of claim 11, wherein the referral fee is based on a degree of communications resources provided to the VIP radio by the one or more secondary radios.

13. The method of claim 11, wherein the at least one communications need comprises one of a throughout need, reduced latency need, or a number of communications channels need.

14. A method for penalizing a cognitive radio, the method comprising:
identifying selfish communications behavior of a first cognitive radio;
communicating with a second cognitive radio to validate the identified selfish behavior of the first cognitive radio; and
in response to validation, providing a central authority with information indicative of the selfish behavior of the first cognitive radio.

15. The method of claim 14, further comprising:
providing the central authority with information indicative of validation provided by the second cognitive radio.

16. The method of claim 14, further comprising delivering a punishment warrant to the first cognitive radio, wherein the punishment warrant, when read by an enforcement chip installed on the first cognitive radio, causes the first cognitive radio to adhere to at least one term specified by the punishment warrant.

17. The method of claim 14, wherein the identified selfish communications behavior comprises at least one of (a) transmitting with an unusually large amount of transmission power, (b) not adhering to silent periods in communications, (c) beginning a transmission even when another node in vicinity of the first cognitive radio is already transmitting, and (d) engaging in jamming the communications of other nodes.
